(19) United States
(12) Patent Application Publication
(10) Pub. No.: US 2016/0160750 A1
(43) Pub. Date: Jun. 9, 2016

(54) SYSTEM FOR UTILIZING WASTE HEAT FROM AN EXHAUST GAS SYSTEM

(71) Applicant: MAHLE INTERNATIONAL GMBH, Stuttgart (DE)

(72) Inventors: Rolf Mueller, Steinheim/ Murr (DE); Andreas Neubauer, Weissach Im Tal (DE); Thomas Riemay, Korb (DE); Peter Wieske, Korntal-Muenchingen (DE)

(21) Appl. No.: 14/904,081

(22) PCT Filed: Jun. 27, 2014
(86) PCT No.: PCT/EP2014/063701

§ 371 Date: Jan. 8, 2016

(30) Foreign Application Priority Data
Jul. 11, 2013 (DE) 10 2013 213 569.6

(51) Int. Cl. F02B 39/12; F02B 37/00; F02B 33/40; H02K 49/10

(52) U.S. Cl. CPC F02B 39/12; H02K 49/106; H02K 49/102; F02B 37/00; F02B 33/40

(57) ABSTRACT

A waste heat device for an exhaust gas system may include a hermetically sealed separation sealing off an area against fluid loss. A drive coupling may drivingly connect in a contactless manner a drive to a device configured to receive the drive work. The drive coupling may include a magnetic clutch arrangement having an inlet side arranged within the separation and an outlet side arranged outside the separation. The outlet side may include an outer rotor and the inlet side may include an inner rotor. The outer rotor and the inner rotor may be separated from one another via a sealing cap having an intermediate wall disposed concentric to the rotors. The intermediate wall may form part of the hermetic separation. A plurality of pole bars of a magnetisable material may be arranged on the intermediate wall and be spaced apart in a circumferential direction.

### CROSS-REFERENCE TO RELATED APPLICATIONS

This application claims priority to German Patent Application No. 10 2013 213 569.6, filed Jul. 11, 2013, and International Patent Application No. PCT/EP2014/063701, filed Jun. 27, 2014, both of which are hereby incorporated by reference in their entirety.

### TECHNICAL FIELD

The invention relates to a system for utilizing waste heat from an exhaust gas system, in particular in utility vehicles, with a high-speed turbine able to be driven by a fluid that can be heated by means of the exhaust gas system, which is arranged in an area that is fluidically hermetically sealed and is contactlessly and drivingly coupled to a device arranged outside the hermetically sealed area for utilizing the turbine work.

### BACKGROUND

In the operation of an internal combustion engine, owing to thermodynamic laws great quantities of waste heat occur. It is basically possible and desirable to convert these quantities of waste heat into mechanical work by corresponding thermodynamic processes or respectively to store them in a suitable manner for mechanical work.

For example, the basic possibility exists to vaporize a fluid, such as for example ethanol, refrigerant or ammonia water by means of the waste heat of an exhaust gas system, and to use the thus produced vapour for the operation of a turbine or another expansion- or fluid flow engine. Here, the turbine or respectively the expansion- or fluid flow engine are to operate in a fluidically hermetically sealed area, in order to be able to heat again the fluid used for the operation subsequently without shrinkage and to use it for the operation of the turbine or suchlike. In this context, the problem exists of connecting the turbine or suchlike in terms of drive with a device using the work of the turbine or suchlike.

The invention begins here and proposes embodying the drive connection in a contactless manner by a magnetic transmission arrangement being provided, stepping down the speed of the turbine or suchlike, with drive side within the hermetically sealed area and output side outside this area.

Magnetic transmissions are basically known and can be constructed in an analogous manner to a gear transmission, wherein the teeth of the gear wheels are replaced by “magnetic teeth”, i.e. instead of a toothing, permanent magnets are arranged on the circumference of a wheel, which interact with magnetic areas of opposed polarity on the circumference of a further wheel. Here, between the wheels a fluidically tight wall can be provided, of a material, such as e.g. plastic, not or at most slightly altering magnetic fields.

### SUMMARY

It is an object of the invention to provide a structurally simple contactless drive coupling with good efficiency, which in addition enables a stepping down of the output side.

This problem is solved according to the invention in that the drive connection is constructed as a contactless magnetic transmission, in particular as a magnetic reluctance transmission.

A magnetisable or magnetic body is urged between magnetic poles of opposed polarity by a reluctance force into a position in which the magnetic resistance (reluctance) between the two poles of opposed magnetic polarity becomes minimal. In a reluctance motor, this effect is utilized in that on the circumference of a stator, windings are arranged which are able to be electrically energized, with which through correspondingly alternating energization a magnetic alternating field travelling in circumferential direction is generated. Therefore, a star-shaped rotor of magnetisable material, the number of teeth of which is less than the number of windings of the stator, can be “carried along” by the travelling magnetic alternating field. A reluctance transmission serving as a clutch differs from such a reluctance motor substantially only in that the rotating magnetic alternating field is generated by rotating rotor- or ring parts with permanent-magnetised elements or magnetisable elements adjacent in circumferential direction, and namely on the input side of the magnetic reluctance transmission. On the output side, a rotor interacting with this rotating magnetic alternating field is then provided with permanent-magnetised or magnetisable elements.

A particular advantage of the reluctance transmission lies in that the rotating parts can be configured according to a plurality of variants and in particular a great structural freedom exists with regard to the arrangement of permanent-magnetisable elements.

For this, reference is made to the claims and the following explanation of the drawings, by means of which particularly preferred variants of the invention are described in further detail.

### BRIEF DESCRIPTION OF THE DRAWINGS

In the drawings there are shown:

FIG. 1 a highly diagrammatic axial section of a magnetic transmission provided for the invention, and

FIGS. 2 to 7 radial sections according to the section line II-VII in FIG. 1 for different structural variants of the magnetic transmission.

### DETAILED DESCRIPTION

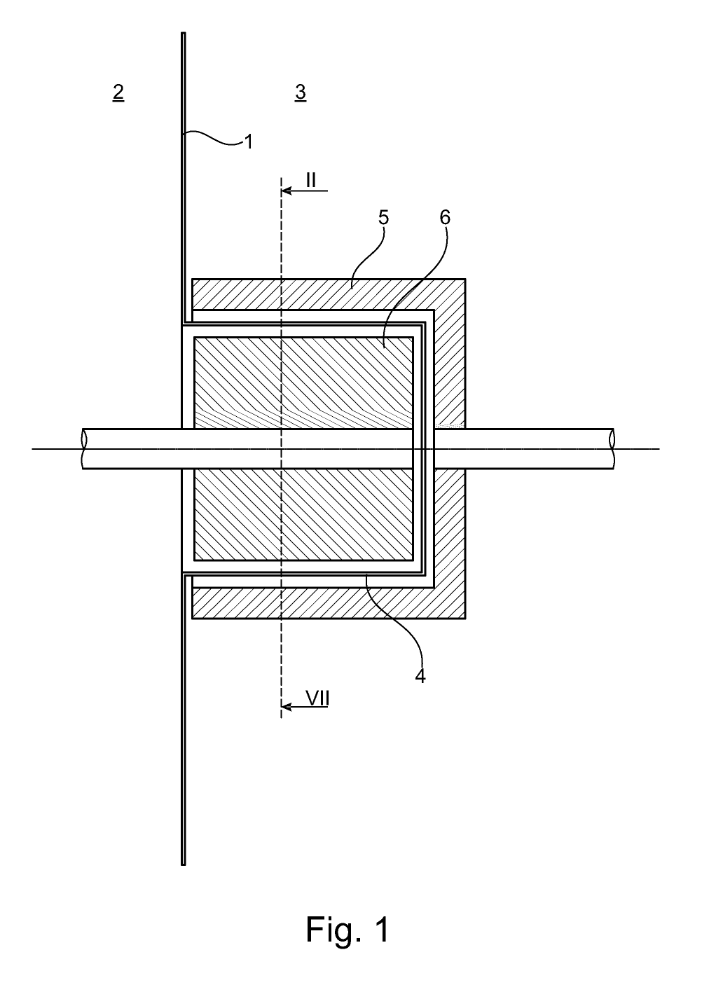

In FIG. 1 a dividing wall 1 forms a hermetically sealed separation between a space 3 communicating with the atmosphere and a space 2, within which a turbine or suchlike, which is not illustrated, is driven by a flowing fluid. On the dividing wall 1 a sealing cap 4 is arranged, which in the illustrated example forms a horizontal cylinder, which is closed at its one end towards the space 3 of the atmosphere and the other end of which is open towards the space 2. Coaxially to the axis of the cylindrical sealing cap 4 there are arranged an outer rotor 5 surrounding the sealing cap 4 in a ring shape, and an inner rotor 6, arranged within the sealing cap 4, of a magnetic transmission which is explained below in further detail, wherein the inner rotor 6 is drivingly connected with the turbine, which is not illustrated, and accordingly forms the input side of the transmission, whilst the outer rotor 5 is provided as coupling output and is drivingly connected with a device, not illustrated in further detail, which is to be driven by the turbine.

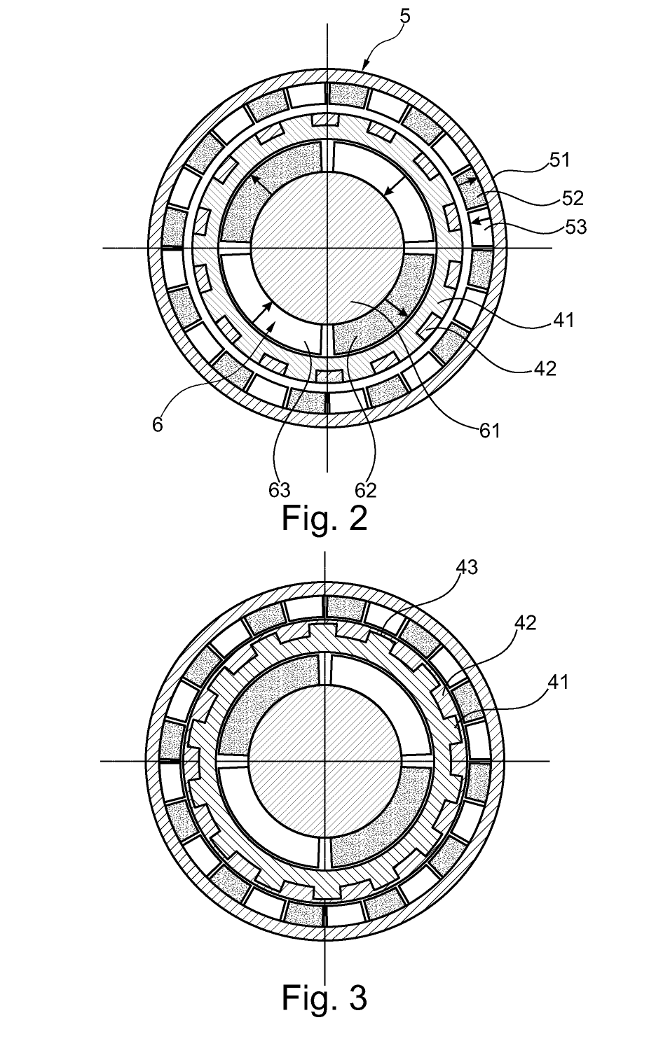

According to a first variant of the magnetic transmission illustrated in FIG. 2, the outer rotor 5 has a casing 51 of magnetisable material, wherein on the inner circumference of the casing 51 strip-shaped permanent magnets 52 and 53 are arranged in an alternating manner, wherein the permanent magnets 52 are magnetised in the one radial direction and the permanent magnets 53 are magnetised in the other radial direction, and the longitudinal axes of the strip-shaped permanent magnets 52 and 53 lie respectively parallel to the cylinder axis of the sealing cap 4. In circumferential direction of the casing 51 therefore a magnetic south pole always follows a magnetic north pole pointing radially inwards.

The inner rotor 6 has a shaft 61 of magnetisable material, for example iron, on the outer circumference of which permanent magnets 62 and 63 which are magnetized in radial direction are arranged, which extend respectively in longitudinal direction of the shaft 61, wherein the permanent magnets 62 and 63 are arranged so that in circumferential direction of the shaft 61 respectively a magnetic north pole follows a magnetic south pole.

The direction of the permanent magnetisation of the magnets 52 and 53 or respectively 62 and 63 is indicated respectively by radial arrows.

The number of the pole pairs formed by the permanent magnets 52 and 53 is designated below as a, the number of the magnetic pole pairs formed by the permanent magnets 62 and 63 is designated as i. In the illustrated example, a=12 and i=2.

Strip-shaped pole bars 42 of magnetisable material, e.g. iron, are arranged on the cylindrical intermediate wall 41, formed in the cylinder wall of the sealing cap 4, between the outer rotor 5 and the inner rotor 6, wherein the longitudinal axes of the pole bars lie respectively parallel to the cylinder axis of the sealing cap 4. Here, p=a+i applies for the number p of the pole bars. Accordingly, in the illustrated example 14 pole bars 42 are present.

When the inner rotor 6 is now rotated with the permanent magnets 62 and 63 and with the shaft 61 in one direction, the magnetic fields generated by the permanent magnets 62 and 63 are modulated by the pole bars 42 on the fixed intermediate wall 41 or respectively the stationary sealing cap 4 in FIG. 1, with the result that the outer rotor 5 and accordingly the casing 51 with the permanent magnets 52 and 53 rotates in the opposite rotation direction to the rotation direction of the inner rotor 6, wherein the rotation speed of the outer rotor 5 is stepped down according to the ratio i:a.

The embodiment of FIG. 3 differs from the previously described embodiment of FIG. 2 substantially only in that the pole bars 42 on the intermediate wall 41 are connected with one another in a yoke-like manner by a casing 43 of magnetisable material. The function of this embodiment corresponds to the function of the embodiment according to FIG. 2.

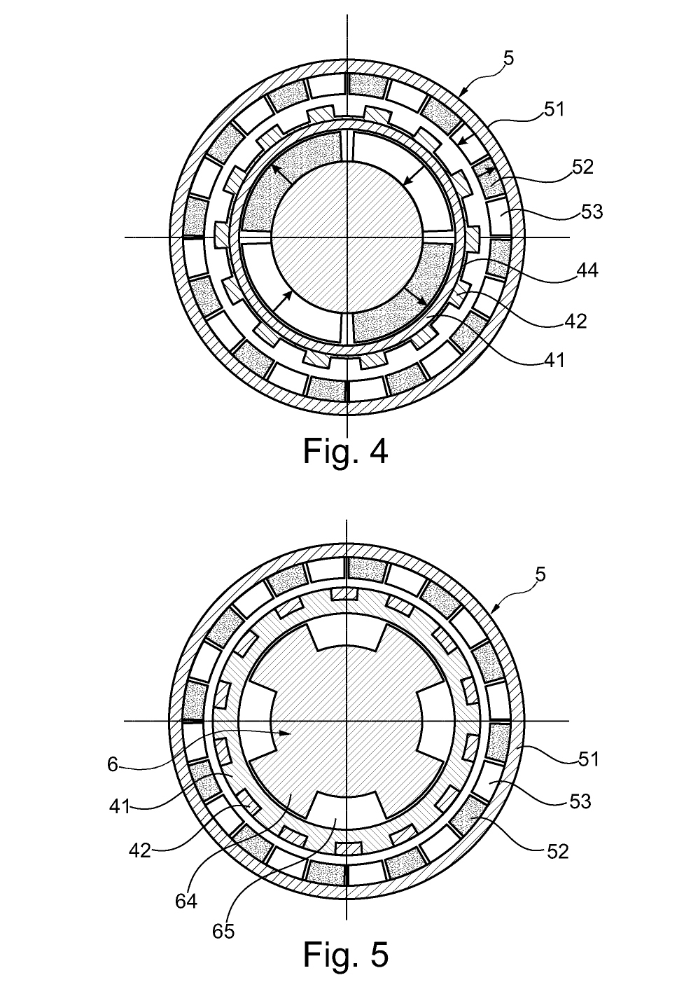

The embodiment of FIG. 4 differs from the embodiment of FIG. 3 substantially in that the pole bars 42 are arranged in the manner of an outer toothing on a casing 44 of magnetisable material, wherein this casing 44 is arranged on the intermediate wall 41.

Here, also, the function is achieved in accordance with the embodiment of FIG. 2.

The embodiment of FIG. 5 corresponds with respect to the construction of the outer rotor 5 with the casing 51 and the permanent magnets 52 and 53 to the embodiment of FIG. 2. The same applies with respect to the construction of the sealing cap 4 with the intermediate wall 41 and the pole bars 42.

In contrast, the inner rotor 6, deviating from the embodiments illustrated hitherto, is without permanent-magnetic elements and has a body consisting of magnetisable material with teeth 64 pointing radially outwards and with tooth gaps 65 arranged therebetween in circumferential direction, wherein the teeth and tooth gaps have approximately identical widths in circumferential direction.

The number j of the tooth pairs formed by the teeth 64 corresponds to the number i of pole pairs, which in the embodiment of FIG. 2 are formed by the permanent magnets 62 and 63. On rotation of the inner rotor 6, the outer rotor of the embodiment of FIG. 5 rotates in the opposite direction, wherein the rotation speeds of the outer rotor are stepped down in the ratio j:a.

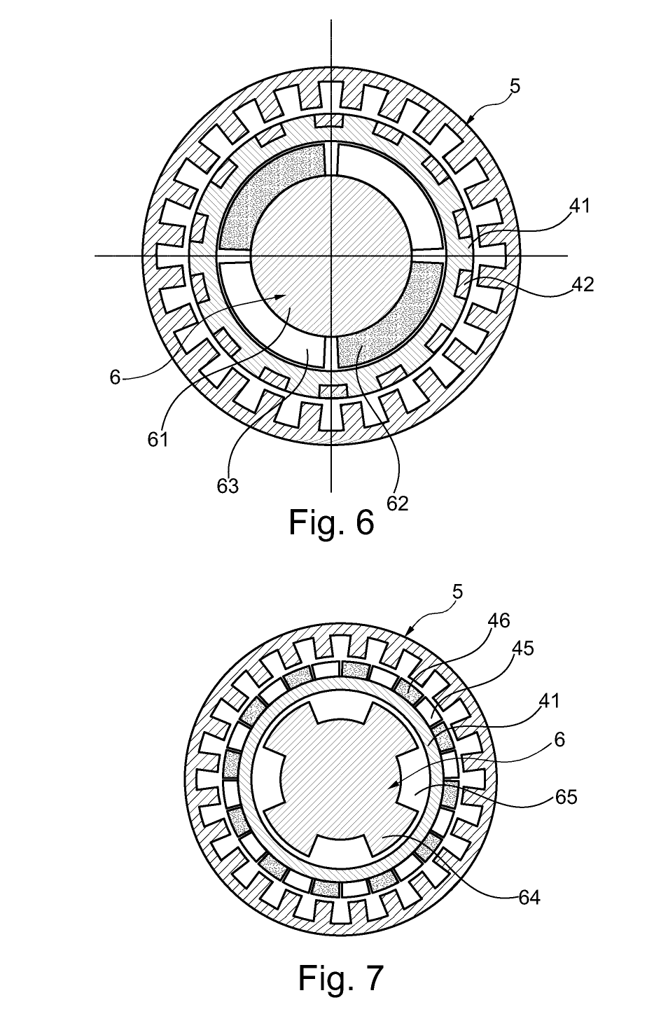

The embodiment of FIG. 6 coincides with regard to the inner rotor 6 and the sealing cap 4 or respectively the intermediate wall 41 and the pole bars 42 to the embodiment of FIG. 2. However, the outer rotor 5, in contrast to the embodiment of FIG. 2, has no permanent-magnetised elements at all. Rather, the outer rotor consists of a casing 51 of magnetisable material and of radially inwardly directed teeth 54 of magnetisable material formed thereon on the inner side, wherein the number z of tooth pairs of the outer rotor 5 in FIG. 6 corresponds to the number a of the pole pairs of the permanent magnets 52 and 53 of FIG. 2. On rotation of the inner rotor 6, the outer rotor 5 rotates in the opposite direction, wherein the rotation speeds of the outer rotor 5 are stepped down in the ratio z:i.

The embodiment of FIG. 7 has on the one hand an inner rotor according to the embodiment of FIG. 5 and on the other hand an outer rotor 5 according to the embodiment of FIG. 6. Deviating from all previously described embodiments, permanent magnets 45 and 46 are arranged on the sealing cap 4 or respectively on the intermediate wall 41, which permanent magnets are polarised magnetically respectively in radial direction, wherein the permanent magnets 46 are polarised respectively opposed to the permanent magnets 45. The number p of the pole pairs formed by the permanent magnets 45 and 46 corresponds here to the sum of the number z of tooth pairs on the inner circumference of the outer rotor 5 and the number j of the tooth pairs on the outer circumference of the inner rotor 6. On rotation of the inner rotor, the outer rotor rotates in turn in the opposite direction, wherein the rotation speeds of the outer rotor 5 are stepped down in the ratio of j:z.

From the structural point of view, the embodiment of FIG. 7 is particularly preferred, because permanent-magnetised elements are arranged exclusively on a stationary part, i.e. on the sealing cap or respectively on the intermediate wall 41. Here, the possibility exists to embed the permanent magnets 45 and 46 into a non-magnetisable plastic material, which is provided for the sealing cap 4 or respectively the intermediate wall 41.

With regard to the transmissible torques, the embodiments of FIGS. 2 and 3 are advantageous, in which respectively outer and inner rotor have permanent-magnetised elements.

In terms of function, it is basically possible in all illustrated embodiments to arrange the ring-shaped intermediate wall 41 rotatably and to arrange either the outer rotor 5 or the inner rotor 6 so as to be stationary. In such a case, the two rotatable parts are coupled to one another magnetically. However, a separate sealing cap of non-magnetisable material would then have to be provided between the rotatable parts, in order to ensure the desired hermetic separation between the space 2 and the space 3 in FIG. 1. In the embodiments illustrated in the drawings in FIGS. 2-7, in contrast, the stationary intermediate wall 41 undertakes on the one hand the separation of the spaces 2 and 3 and on the other hand, by means of the pole bars 42 arranged on it or respectively the permanent magnets 45 and 46, the additional function of a generation or modulation of magnetic fields.

As a whole, the structural expenditure thereby remains relatively small.

1. A waste heat device for an exhaust gas system, comprising: a high-speed turbine driven by a fluid that is heatable via a waste heat flow, the turbine arranged in an area sealed off against fluid loss via a hermetically sealed separation and drivingly connected via a drive coupling on an output side in a contactless manner to a device provided for receiving the turbine work arranged outside of the hermetic separation, wherein the drive coupling includes a magnetic clutch arrangement having an inlet side arranged within the hermetic separation and an outlet side arranged outside the hermetic separation, wherein the outlet side includes an annular outer rotor and the inlet side includes an inner rotor arranged concentric thereto about a rotor axis, the outer rotor and the inner rotor separated from one another by a sealing cap having an intermediate wall disposed concentric to the outer rotors and the inner rotor, the intermediate wall configured to form a part of the hermetic separation,
wherein the magnetic clutch arrangement is configured as a magnetic transmission, and wherein a plurality of pole bars of magnetisable material with a longitudinal axis parallel to the rotor axis are arranged on the intermediate wall and spaced apart from one another in a circumferential direction of the rotor axis.

2. The device according to claim 1, wherein the magnetic transmission is configured to step down a rotation speed of the turbine.

3. The device according to claim 1, further comprising a plurality of radially polarised permanent magnets having a magnetic polarisation alternating in the circumferential direction arranged in pairs on at least one of the inner rotor and the outer rotor, such that in the circumferential direction respectively a magnetic north pole follows a magnetic south pole.

4. The device according to claim 3, wherein a number of the pole bars corresponds to the sum of a number of the magnetic pole pairs of the outer rotor and a number of the magnetic pole pairs of the inner rotor.

5. The device according to claim 1, further comprising a plurality of radially polarised permanent magnets having a magnetic polarisation alternating in the circumferential direction arranged on the intermediate wall, such that in the circumferential direction a magnetic north pole follows a magnetic south pole, wherein the inner rotor has a body of magnetisable material and teeth disposed on an outer circumference side and tooth gaps extended therebetween in the circumferential direction, and wherein the outer rotor has a casing of magnetisable material and radially inwardly directed teeth of magnetisable material arranged thereon.

6. The device according to claim 5, wherein a number of the magnetic pole pairs on the intermediate wall corresponds to the sum of a number of tooth pairs on the outer rotor and a number of tooth pairs on the inner rotor.

7. The device according to claim 1, wherein the inner rotor has a body of magnetisable material.

8. The device according to claim 7, wherein the body of magnetisable material of the inner rotor further includes teeth disposed on an outer circumferential side and at least one tooth gap extended therebetween in the circumferential direction.

9. The device according to claim 8, wherein a number of the pole bars on the intermediate wall corresponds to the sum of a number of tooth pairs of the inner rotor and a number of pole pairs on a casing of the outer rotor.

10. The device according to claim 7, further comprising at least one permanent magnet disposed about an outer circumference side of the body of the inner rotor.

11. The device according to claim 1, wherein the magnetic transmission is configured as a reluctance transmission.

12. The device according to claim 1, further comprising a plurality of permanent magnets polarized in a radial direction disposed between the outer rotor and the intermediate wall, wherein the plurality of permanent magnets have a magnetic polarisation alternating in the circumferential direction.

13. The device according to claim 12, further comprising another plurality of permanent magnets polarised in the radial direction arranged on the intermediate wall and having a magnetic polarisation alternating in the circumferential direction.

14. The device according to claim 13, wherein the inner rotor has a body composed of a magnetisable material and a plurality of teeth disposed on an outer circumference side and at least one tooth gap extending between the plurality to teeth in the circumferential direction.

15. The device according to claim 12, further comprising another plurality of permanent magnets polarized in the radial direction disposed between the inner rotor and the intermediate wall and having a magnetic polarisation alternating in the circumferential direction.

16. The device according to claim 15, wherein a number of pole bars of the intermediate wall correspond to the sum of a number of magnetic pole pairs of the outer rotor and a number of magnetic pole pairs of the inner rotor.

17. The device according to claim 2, wherein the inner rotor has a body of a magnetisable material and a plurality of radially polarised permanent magnets disposed on an outer circumferential side having a magnetic polarisation alternating in the circumferential direction.

18. The device according to claim 2, wherein the inner rotor has a body of a magnetisable material and a plurality of teeth disposed on an outer circumferential side, wherein at least one tooth gap is defined between the plurality to teeth extending in the circumferential direction

19. A waste heat device for an exhaust gas system, comprising:
a hermetically sealed separation sealing off an area against fluid loss, the area configured to receive a high-speed turbine driven by a fluid that is heatable via a waste heat flow;
a drive coupling via which the turbine is drivingly connected on an output side in a contactless manner to a device arranged outside of the separation configured for receiving the turbine work, wherein the drive coupling includes a magnetic clutch arrangement having an inlet side arranged within the separation and an outlet side arranged outside the separation, wherein the outlet side includes an annular outer rotor and the inlet side includes an inner rotor arranged concentric thereto about a rotor axis;
a sealing cap separating the outer rotor from the inner rotor and having an intermediate wall disposed concentric to the outer rotor and the inner rotor, wherein the intermediate wall forms at least part of the separation, and wherein the magnetic clutch arrangement is configured as a magnetic transmission;
a plurality of pole bars of a magnetisable material having a longitudinal axis parallel to the rotor axis arranged on the intermediate wall and spaced apart from one another in a circumferential direction of the rotor axis; and
a plurality of permanent magnets polarised in a radial direction of the rotor axis arranged on at least one of the inner rotor and the outer rotor, wherein the plurality of permanent magnets have a magnetic polarisation alternating along the circumferential direction.

20. The device according to claim 19, wherein a number of the plurality of pole bars corresponds to the sum of a number of magnetic pole pairs of the plurality of permanent magnets arranged on at least one of the inner rotor and the outer rotor.
